(19) United States
(12) Patent Application Publication
(10) Pub. No.: US 2014/0327651 A1
(43) Pub. Date: Nov. 6, 2014

(54) INDICATOR OF ENTERING A SECURE PASWORD ON A TOUCH SENSOR

(71) Applicant: CIRQUE CORPORATION, Salt Lake City, UT (US)

(72) Inventor: Jared G. Bytheway, Sandy, UT (US)

(73) Assignee: CIRQUE CORPORATION, Salt Lake City, UT (US)

(21) Appl. No.: 14/271,138

(22) Filed: May 6, 2014

Related U.S. Application Data
(60) Provisional application No. 61/819,748, filed on May 6, 2013.

(51) Int. Cl. G06F 3/041; G06F 3/044

(52) U.S. Cl. CPC G06F 3/0416; G06F 3/044
USPC 345/174

(57) ABSTRACT

A system and method for securing access to a device where access is enabled through a touch sensor, the system providing a visual feedback system through a substantially opaque touchpad, thereby enabling a touch sensor without a display to provide visual feedback regarding entry of a password, including a means for restarting entry of a password, and even providing a display of numbered keys.

### BACKGROUND OF THE INVENTION

1. Field of the Invention

This invention relates generally to touch sensors and security. More specifically, the present invention relates to a secure system for entering a password or other information to gain access to data that is intended to be secure.

2. Description of Related Art

There are several designs for capacitance sensitive touch sensors. It is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24. Although the CIRQUE® touchpad described above uses a grid of X and Y electrodes 12, 14 and a separate and single sense electrode 16, the sense electrode can actually be the X or Y electrodes 12, 14 by using multiplexing.

Security is an issue when using a touch sensor because they are used in so many devices that are difficult to secure, or that may be accessed without permission. These devices may be stationary such as a desktop computer or a kiosk, or they may be portable such as tablets or smartphones. It would be an advantage over the prior art to provide a means for securing any device that uses a touch sensor to enable access.

### BRIEF SUMMARY OF THE INVENTION

In a preferred embodiment, the present invention is a system and method for securing access to a device where access is enabled through a touch sensor, the system providing a visual feedback system through a substantially opaque touchpad, thereby enabling a touch sensor without a display to provide visual feedback regarding entry of a password, including a means for restarting entry of a password, and even providing a display of numbered keys.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

FIG. 2 is a top view of a touch sensor showing one possible layout of feedback LEDs, a mode of operation indicator and keys for entering data.

FIG. 3 is a top view of the touch sensor of FIG. 2 showing one possible layout where an LED is providing feedback.

FIG. 4 is a top view of the touch sensor of FIG. 2 showing one possible layout where a different LED is providing feedback.

FIG. 5 is a top view of the touch sensor of FIG. 2 showing one possible layout after successful entry of a password.

FIG. 6 is a top view of the touch sensor of FIG. 2 showing one possible layout after a failed entry of a password.

FIG. 7 is a top view of the touch sensor of FIG. 2 showing one possible layout that includes a numerical keyboard for entry of a password.

FIG. 8 is a block diagram of one embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with devices including but not limited to “capacitive touch sensor”, “touch panel”, “touchpad” and “touch screen”.

Entering a personal identification number (PIN) on a touch sensor may be simpler, easier and a better experience for the user than entering data on a keypad or keyboard. More importantly, the use of a keypad and keyboard may be less secure than using a touch sensor as taught in the embodiments of the present invention.

The embodiments of the present invention may provide a secure method of entering a password or other secure information using a touch sensor. Hereinafter, the words “password”, “secure character”, “access code” or “personal identification number” (PIN) may be used interchangeably throughout this document. It is understandable that entering a password on a substantially opaque touch sensor such as a touchpad may be confusing without some feedback to the user regarding the data being entered.

Accordingly, the present invention may be the use of embedded and secure lights in combination with a touch sensor to provide visual cues that the touch sensor may be operating in a secure operating mode. A secure operating mode may be used, for example, when entering a password or other data that should be kept secure. The secure operating mode may be characterized as a mode in which all data that is entered by using a touch sensor is secure because it is not passed to a host or other device.

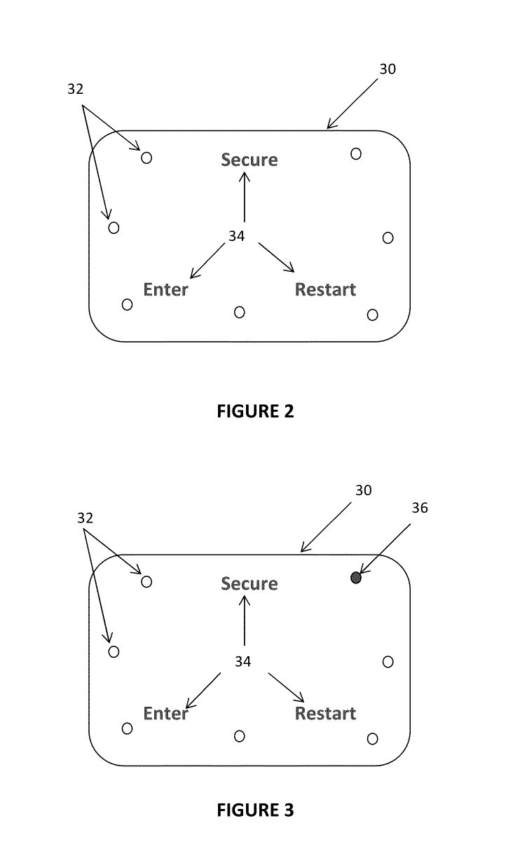

FIG. 2 is a top view of a first embodiment of the present invention. This figure shows a touch sensor 30 having a plurality of lights 32 that are visible through a surface of the touch sensor. The specific locations of the lights 32 are only an example of possible locations. The lights 32 may be disposed in any desirable pattern or locations.

The first embodiment of the touch sensor 30 also a plurality of different messages 34. These messages may be visible on the touch sensor 30 at all times, or they may only be visible if they are illuminated by a light source 32 that may be disposed underneath a surface of the touch sensor. Thus, a light may be formed in the shape of the messages 34, or the messages may be pre-printed on the surface of the touch sensor 30 and then illuminated from underneath to make them more visible when operating in a secure operating mode. The purpose of illuminating the messages 34 is to provide a visual indicator to a user when a particular function or mode of operating is active.

In this first embodiment, FIG. 2 shows the messages SECURE, ENTER and RESTART on the surface of the touch sensor 30. In this embodiment, the word SECURE may be illuminated or made visible when the touch sensor 30 enters a secure operating mode. FIG. 2 is an illustration of the touch sensor 30 before any characters have been entered. No entry of characters has yet begun because none of the lights 32 are lit.

In a first embodiment, the touch sensor 30 may respond to the entering of secure characters by illuminating one light 32 for every valid password character that is recognized by the touch sensor, or for any combination of secure characters that are correctly entered. The touch input may be taken as absolute data as opposed to relative data in a typical touch sensor operating mode. A password may include 3 to 6 characters which is a common length for a PIN, but may contain any number of characters for a function of operating mode that may require more secure access.

While a visual feedback system may be one aspect of the embodiments of the present invention, it should be understood that the lights 32 may be any desirable source of generating illumination, and includes such illumination sources as light emitting diodes (LEDs). However, the present invention is not limited to the use of LEDs for transmitting light through a surface of the touch sensor 30. Any light source that enables transmission through a surface of the touch sensor 30 may be used. Accordingly, the surface of the touch sensor may vary from translucent to completely transparent in order to enable the transmission of light to a user.

In a first embodiment where a password, access code or other secure character data is being entered, a valid character may be entered using the following method. The first step may be to press a virtual or mechanical button or key to activate a secure operating mode. It should be apparent that any method for activating the secure operating mode may be used and should not be considered as limited to the specific methods described herein.

The next step may be to enter a number, letter or symbol on the touch sensor 30. In one embodiment the number, letter or symbols may be displayed on a screen or on the touch sensor. In an alternative embodiment, the number, letter of character may be traced on the touch sensor 30. What is important is that the number, letter of character is being entered on the touch sensor 30 that is operating in a secure operating mode.

The next step may be to have the number of fingers that make contact with the touch sensor 30 be a part of secure character entry. For example, a user might change the number of fingers that are making contact in order to affect secure character entry. Furthermore, the fingers may also change position.

Finally, the last step may be to have the finger or fingers move. One or more fingers may make a change in the direction vector of one or more fingers being moved across the surface of the touch sensor 30. This change in direction may include starting, stopping, and changing direction by moving in a new direction at a specific angle relative to the previous direction. For example, the user may change direction and move at an angle that is 90 degrees, 45 degrees (or any desired angle) relative to a straight line direction of travel of a previous path.

The description above should only be considered as an example of a method of entering secure characters and should not be considered as limiting the different ways that the touch sensor 30 may be touched in order to enter secure characters.

In the first embodiment, with each recognized secure character that is entered, a new light 32 may be activated. The lights 32 may remain lit until all the secure characters of the password are successfully entered if there are enough lights for all the characters to be represented. Alternatively, a previously activated light 32 may be turned off when a new light is activated for a new character. The lights 32 may therefore operate in a chase mode and continue to advance in a predetermined sequence until all of the secure characters are entered.

In the example shown in FIG. 2, there are eight lights 32 in the perimeter of the touch sensor 30. There may be more or less lights 32, and the number should not be considered as a limiting factor. There may be a unique light 32 that is illuminated for each secure character, or the lights may be illuminated in a sequence that allows lights to be turned off and then turned on again if needed.

It may also be possible to use the lights 32 in a mode that is not secure. Accordingly, a secure mode of operation may be indicated by illumination of the message SECURE.

While eight lights 32 are shown in FIG. 2, in an alternative embodiment, the secure operating mode and entry of secure characters may be performed using a little as two lights. If only two lights 32 are used to indicate the successful entry of secure characters, the lights 32 would be activated and then be extinguished in an alternating pattern. In other words, when one light 32 is lit, the other light is off, and the sequence may proceed in an alternating back and forth pattern until all of the secure characters are entered.

In the first embodiment, a secure operating mode may end when a matching secure character sequence is entered correctly and completely. Alternatively it may be necessary to actuate a button or provide some type of input after all the secure characters are entered and thereby manually terminate the secure operating mode.

The first embodiment may also include an indication not only of a secure operating mode but also a mode for entering secure characters when the message ENTER is illuminated, and for restarting or re-entering secure characters when the message RESTART is illuminated. It should be understood that these functions or modes may or may not be mutually exclusive. For example, when entering a new set of secure characters such as a new password, both the messages SECURE and ENTER may be illuminated to indicate that secure characters are being entered for a password, and that the touch sensor 30 is in the secure operating mode.

The present invention is not limited to the three functions or modes that are illustrated the messages 34 of this first embodiment. More or less functions or modes may be indicated on the touch sensor 30.

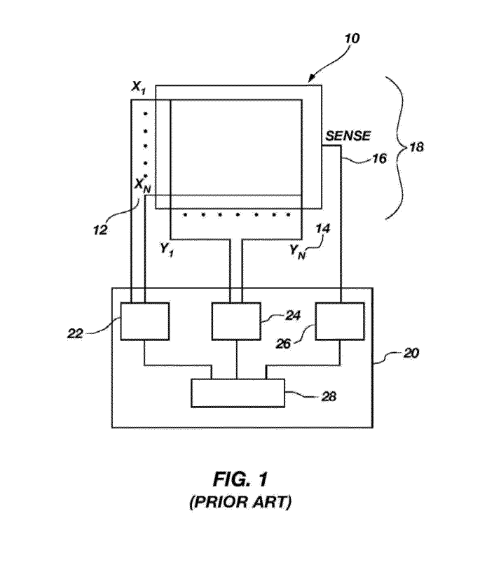

Feedback from the lights 32 when the touch sensor 30 is in the secure operating mode may take different forms. Furthermore, various visual feedback signals may be used to indicate status. For example, all the lights 32 may flash after an invalid secure character is entered. In another example, a password may need to be set. When a password is being set, the touch sensor 30 may need to be in the secure operating mode. To indicate that the touch sensor 30 is ready for the entry of a password, one or more indicators may be used. For example, as shown in FIG. 1, the SECURE and ENTER message indicators may both be activated and remain lit until the function or mode is terminated.

In an alternative embodiment of the present invention when a substantially opaque touchpad is used as the touch sensor 30, the touchpad may include lights 32 that are disposed under the touch sensor but which are still visible as a form of backlighting through a surface of the touch sensor. Accordingly, a substantially opaque touch sensor 30 may still enable visual information to be displayed through a surface that allows at least some transmission of light. Alternatively the surface of the touch sensor 30 may be translucent in order to enable transmission of light.

FIG. 2 is an illustration of a top view of the touch sensor 30. The small circles indicate a location where the lights 32 may be located. The message SECURE is lit from behind, as are the messages ENTER and RESTART. The message SECURE becomes lit when the touch sensor 30 has entered a secure operating mode. FIG. 2 illustrates an initial secure mode when no lights 32 are being illuminated because no secure characters have yet been entered.

FIG. 3 is an illustration of a top view of the touch sensor 30 where a first light 36 of the lights 32 is illuminated to provide feedback to the user that a first character of a sequence of secure characters has been entered.

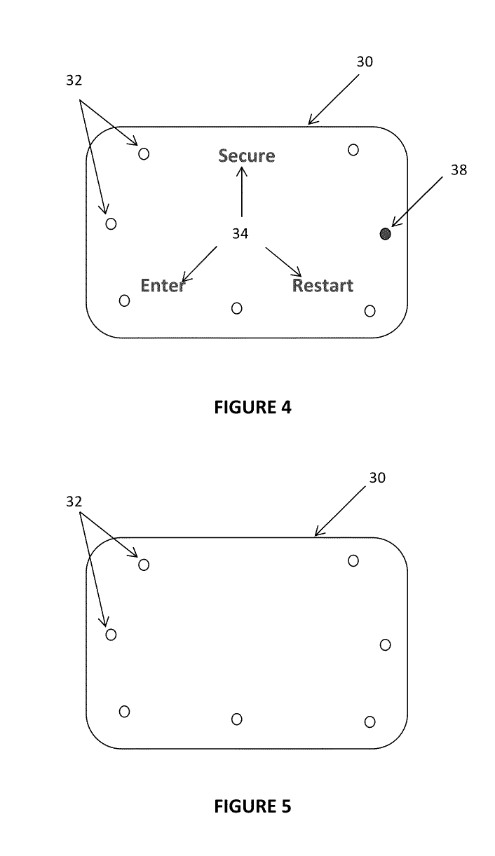

FIG. 4 is an illustration of a top view of the touch sensor 30 where a second light 38 of the lights 32 is illuminated to provide feedback to the user that a second character of a sequence of secure characters has been entered. In this example, the lights 32 are performing a chase sequence where a previous light 32 is terminated. Alternatively, the previous lights 32 may remain illuminated until the sequence of secure characters is entered completely.

FIG. 5 is an illustration of a top view of the touch sensor 30 that shows that the backlit words 34 are no longer illuminated and all the lights 32 are off. This is the appearance of the touch sensor 30 when the entry of the sequence of secure characters is complete and the secure operating mode is turned off.

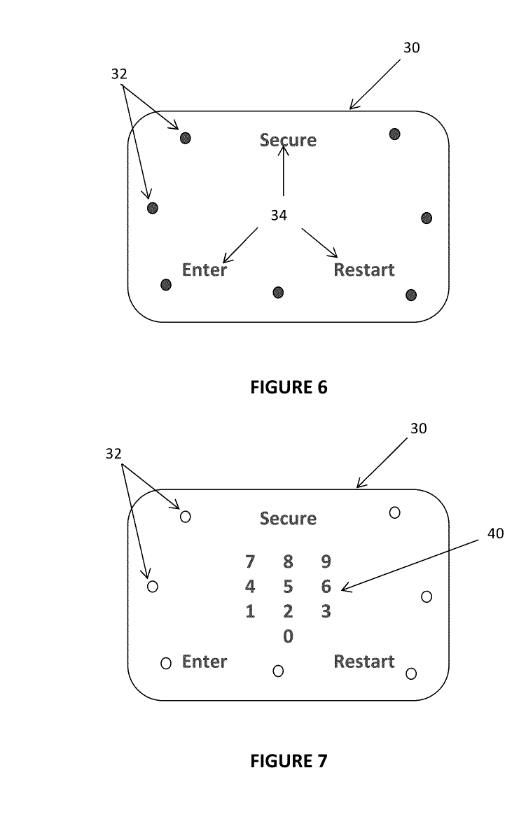

In contrast, FIG. 6 is an illustration of a top view of the touch sensor 30 showing all of the lights 32 being illuminated. The lights 32 may be steadily illuminated or they may flash. The steadily illuminated or flashing may be used to indicate status of entering the sequence of secure characters. For example, when the sequence of secure characters is determined to be invalid, the user may be given feedback that the sequence of secure characters must be re-entered.

It should be understood that the exact position, size and number of lights 32 under the touch sensor 30 used to provide feedback to the user may be adjusted as desired, and is not a limiting factor of the present invention. In addition, the lights 32 may be lined up along an edge of the touch sensor 30 or arranged in a desired pattern. Furthermore, any number of alphanumeric characters or symbols may be illuminated in any location.

In another aspect of the invention, backlighting under the touch sensor 30 may be used to provide a guide for input. For example, consider FIG. 7 in which a plurality of illuminated characters 40 such as the numbers shown may be arranged to form a numeric keypad. The position of the backlighting may also correspond to a location that may be touched on the touch sensor 30 in order to enter the associated backlit character. Thus, the position of the illuminated characters 40 may be known so that when contact is made, an associated character may be entered as input.

Important aspects of the embodiments of the invention include, but should not be considered as limited to, direct feedback for valid entries. A valid entry only means that a character was entered, but not whether the correct character was entered. Feedback regarding validity of an entire password may only be provided when the entire password is entered. This may be indicated when a return key is entered, or the correct number of secure characters is entered.

Feedback may include: 1) lights 32 shown in the examples above and driven by a secure touch controller; 2) sounds from a small speaker connected to the touch sensor 30 and driven by a secure touch controller; and 3) vibration from a haptics motor connected to the touch sensor 30 and which vibrates when a valid (but not necessarily a correct) secure character is entered, and driven by the secure touch controller. The haptics motor may be used to indicate a valid sub-element when entering secure characters. For example, if a user is tracing a symbol on the touch sensor 30, the haptics motor may vibrate to indicate to the user that the user has changed direction or that a correct sequence has been entered.

Another aspect of the invention is that a secure touch controller may not output any touch sensor 30 position data while in the secure operating mode. This action may prevent the interception of any secure characters by malware or by a snooped electrical signal from the touch sensor 30. In a related aspect, touch input may be taken as absolute data (vs. relative in typical touch sensor mode).

Another feature of the present invention may be that the user is prevented from entering secure characters when not in a secure operating mode. The SECURE message indicator 34 or some other indicator that the touch sensor 30 is operating in the secure operating mode may only be illuminated by the secure touch controller.

Another feature of the present invention may be that the SECURE message indicator 34 may be a default mode of operation. In this second embodiment of the invention, the touch sensor 30 may indicate that the secure mode is not in operation by changing the message from SECURE to UNSECURE. The illumination of the messages 34 may be under the control of the secure touch controller.

After the secure characters such as a password or a PIN are successfully entered, the secure touch controller may transmit an “unlock” signal to a host processor, thereby enabling access to a system or function that is being secured by the secure characters. Transmitting this information to the host may be in the clear, encrypted in a data packet, part of a regular protocol communication or by a dedicated signal in a physically secured conductor.

In another aspect of the embodiments of the present invention, a host or system may prompt a user to enter an initial password or to change a current password. The host may instruct a secure touch controller to begin functioning in a secure operating mode. The secure touch controller may capture the input of the secure characters and store them for subsequent use. The host may never receive any of the secure characters from the secure touch controller in order to maintain security of the secure characters.

The secure touch controller may store several passwords for various security functions or levels or for various users. These various passwords may be conveyed from the host to the secure touch controller or the secure touch controller may just try to match the entered password with a list of passwords stored in a secure memory.

In a final aspect of the invention, the lights 32 and the words 34 may be protected from probing. For example, the lights 32 and the words may be disposed in a secure fence which may include a secure IC package (Multi-Chip Module), in a secure mesh or in a secure capacitance volume.

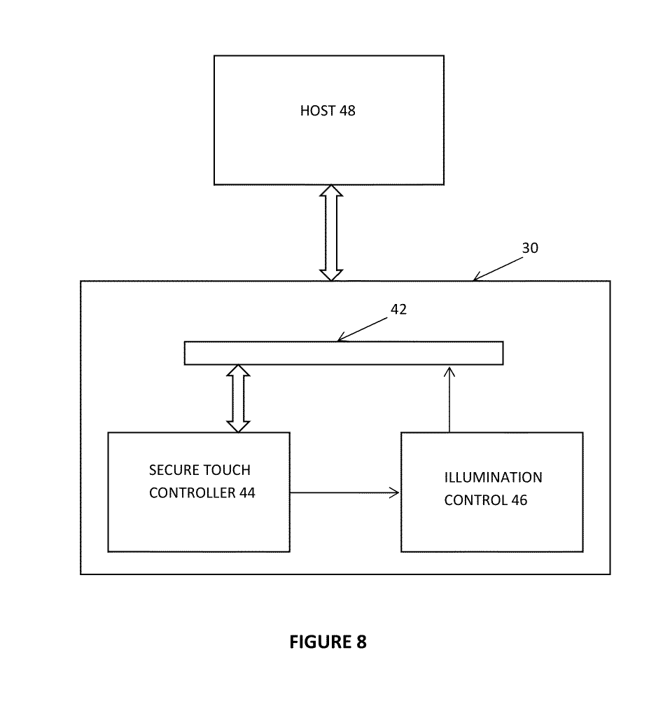

FIG. 8 is an illustration of a block diagram of the elements of the touch sensor 30 as described in at least the first embodiment above. In the first embodiment, the touch sensor 30 may be comprised of a touch sensor electrode grid 42, a secure touch controller 44 and an illumination control module 46. The illumination control module 46 may be any processor that can control illumination of the lights 32 and the messages 34. The touch sensor 30 may communicate with a host 48.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for providing visual feedback on a touch sensor, said method comprising:
1) providing a touch sensor having a surface;
2) disposing at least one light under the surface of the touch sensor, wherein the at least one light is capable of at least partially transmitting light through the surface;
3) entering a secure operating mode of the touch sensor; and
4) providing a visual signal through the surface of the touch sensor using the at least one light to indicate that the touch sensor is operating in the secure operating mode.

2. The method as defined in claim 1 wherein the method further comprises providing a substantially opaque material for the surface of the touch sensor.

3. The method as defined in claim 1 wherein the method further comprises providing a plurality of lights under the surface of the touch sensor to provide the visual signal.

4. The method as defined in claim 3 wherein the method further comprises providing at least one alphanumeric message on the surface of the touch sensor and illuminating the at least one alphanumeric message using at least one of the plurality of lights, wherein the at least one alphanumeric message indicates that the touch sensor is in a secure operating mode when it is illuminated.

5. The method as defined in claim 1 wherein the method further comprises receiving at least one secure character on the surface of the touch sensor.

6. The method as defined in claim 5 wherein the method further comprises providing a secure touch controller in the touch sensor, wherein the secure touch controller receives the at least one secure character.

7. The method as defined in claim 6 wherein the method further comprises storing the at least one secure character in the secure touch controller.

8. The method as defined in claim 6 wherein the method further comprises providing an illumination control for controlling the at least one light.

9. The method as defined in claim 3 wherein the method further comprises creating a sequence of chase lights from the plurality of lights, wherein a first chase light is illuminated when a first secure character is entered, and proceeding to a next chase light as each secure character is entered.

10. The method as defined in claim 9 wherein the method further comprises having at least two chase lights.

11. A system for providing visual feedback on a touch sensor, said system comprised of:
a touch sensor having a surface and a secure operating mode; and
at least one light disposed under the surface of the touch sensor, wherein the at least one light is capable of at least partially transmitting light through the surface to provide a visual signal through the surface of the touch sensor using the at least one light to indicate that the touch sensor is operating in the secure operating mode.

12. The system as defined in claim 11 wherein the system is further comprised of a substantially opaque material for the surface of the touch sensor.

13. The system as defined in claim 11 wherein the system is further comprised of a plurality of lights under the surface of the touch sensor to provide the visual signal.

14. The system as defined in claim 13 wherein the system is further comprised of at least one alphanumeric message disposed on the surface of the touch sensor and illuminating the at least one alphanumeric message using at least one of the plurality of lights, wherein the at least one alphanumeric message indicates that the touch sensor is in a secure operating mode when it is illuminated.

15. The system as defined in claim 11 wherein the system is further comprised of a secure touch controller disposed in the touch sensor, wherein the secure touch controller receives at least one secure character from the touch sensor.

16. The system as defined in claim 15 wherein the system is further comprised a secure memory disposed in the secure touch controller for storing the last one secure character.

17. The system as defined in claim 16 wherein the system is further comprised of an illumination control for controlling the at least one light.

18. The system as defined in claim 13 wherein the system is further comprised of a sequence of chase lights from the plurality of lights, wherein a first chase light is illuminated when a first secure character is entered, and proceeding to a next chase light as each secure character is entered.

19. The system as defined in claim 18 wherein the system is further comprised of at least two chase lights.
